(19) United States
(12) Patent Application Publication
(10) Pub. No.: US 2012/0204981 A1
(43) Pub. Date: Aug. 16, 2012

(54) DRINKING AND DOMESTIC WATER SYSTEM

(76) Inventors: Martin COERDT, Olsberg (DE); Roland Foitzik, Olsberg (DE)

(21) Appl. No.: 13/249,906

(22) Filed: Sep. 30, 2011

(30) Foreign Application Priority Data
Feb. 10, 2011 (DE) 102011010840.8

(51) Int. Cl. F15D 1/00

(52) U.S. Cl. 137/563

(57) ABSTRACT

A drinking or domestic water system has a conduit system with a connection to a public water supply system, at least one riser conduit with at least one floor-by-floor conduit branching therefrom and at least one circular conduit branched in the flow direction of the water from the floor-by-floor conduit, at least one consumer connected in the circular conduit, and a return conduit into which the floor-by-floor conduit enters, by means of which it can be secured, avoiding high water consumption and thus operating costs, so that the water in the system meets hygienic conditions. The conduit system composed of supply conduit or riser conduit and return conduit forms a closed circulation conduit in which unit for cooling the water flowing through is integrated so that the drinking or domestic water can be cooled to a predetermined temperature.

### FIELD OF THE INVENTION

The invention relates to a drinking or domestic water system comprising a conduit system that has a connection to a public water supply system, and at least one supply conduit or riser conduit with at least one floor-by-floor conduit branching therefrom and/or at least one circular conduit branched in the flow direction of the water from the riser conduit and/or from the floor-by-floor conduit, and at least one consumer connected at the riser conduit and/or at the floor-by-floor conduit and/or in the circular conduit, as well as a return conduit into which the supply conduit and/or the riser conduit and/or the floor-by-floor conduit and/or the circular conduit enters.

### BACKGROUND OF THE INVENTION

In particular, the invention relates to a system in which cold drinking or domestic water is provided. Same as in systems for hot drinking or domestic water, a growth of germs, such as Pseudomonas aeruginosa (in the following called pseudomonads) or Legionella may occur in systems with cold water, too, if the water temperature is in the range between 9 and 42° C. being favorable to the growth. Reference is made to the document “Mikrobiologisch-hygienische Aspekte des Vorkommens von Pseudomonas aeruginosa im Trinkwasser, Energie/Wasser-Praxis 3, 2009.”

In systems, which are configured, as described for instance in the EP 1 845 207 A1, as circular conduits, the equipment must regularly be flushed for achieving a proper drinking water quality as well as for preventing a heating of the cold water to inadmissibly high temperatures. Hereby, the water consumption considerably increases, same as the respective operating costs. If drinking water is regarded as a food, the water should be kept at a temperature of below 9° C. Reference is made to the above-mentioned document.

Particularly in midsummer it may happen that the fresh water supplied by the water companies distinctly exceeds this temperature. Reference is made to the document “Legionellavermehrung in Kaltwasserleitungen, Arbeitskreis Trinkwasserinstallation and Hygiene, RAS 06/2010.” Even by permanently flushing the conduits, thus the risk of contamination cannot be excluded.

From the EP 1 845 207 A1, a corresponding system is known in the art, wherein upon activation of the flushing all circular conduits are flushed at the same time. For this purpose, a valve is used, by means of which a uniform flushing of all circular conduits is possible. Flushing takes place in regular time intervals, and it does not matter whether or not there is an increased water temperature in the circular conduits. This means, at each flushing a complete, however uncontrolled exchange of the water in the complete system is made.

### OBJECT OF THE INVENTION

Based on this prior art, it is the object of the invention to provide a drinking or domestic water system, by means of which it can be secured, avoiding a high water consumption and thus operating costs, that the water in the system meets hygienic conditions, i.e. no inadmissibly high concentrations of germs, in particular of pseudomonads, are generated.

### SUMMARY OF THE INVENTION

For achieving this object, the invention proposes that the conduit system composed of supply conduit or riser conduit and return conduit forms a closed circulation conduit, and that in this circulation conduit a unit for cooling the water flowing through is integrated, by means of which the drinking or domestic water can be cooled or is cooled to a predetermined temperature.

By this configuration it is achieved that the water in the conduit system can specifically circulate in the corresponding conduits, and the temperature of the water flowing through the system is cooled to a predetermined temperature, i.e. preferably below 9° C., thereby securing that the growth of germs, in particular pseudomonads, is suppressed. For this process, no additional water is required, since the water can circulate in the system, but of course can be drawn off at the consumer points if intended. The circulating water is conducted through a unit for cooling, for instance a cryogenic unit, which cools the water down to a hygienically advantageous temperature, preferably below 9° C. Instead of a direct passage through a cryogenic unit, cooling of the water may also be made by a cold water storage facility, which is supplied by a cryogenic unit.

Under certain circumstances, it may be provided that the connection to the water supply system is located between the exit of the cooling unit and the supply or riser conduit.

In this solution, it is assumed that the water supply system provides the supplied water with a sufficiently low temperature. In this case, the connection to the water supply system can be located between the exit of the cooling unit and the supply or riser conduit.

In particular in summer time, i.e. with high outside temperatures, it is not always guaranteed that the water from the water supply system has a sufficiently low temperature.

For this reason it is preferred that the connection to the water supply system is located in the circular conduit upstream of the entry of the cooling unit.

Herein, the supply of fresh water from the network of the water company is made before cooling by the cryogenic unit or the cold water storage facility. Thus, even with high outside temperatures, as for instance in midsummer, the fresh water supplied from the network of the water company is cooled to a hygienically advantageous temperature.

In order to obtain a uniform flow through all conduit systems, a hydraulic adjustment of the individual conduits among each other is required. This can be made with static conduit control valves, however with the drawback that with long-time water removal in some system parts, improperly flowed-through other system parts could become inadmissibly hot.

In order to achieve in this case nevertheless a sufficient flow through all system parts and to have a temperature-dependent hydraulic regulation, so that preferably a cold water temperature of 9° C. is maintained, it is proposed that in one or each circular conduit with at least one consumer, a controlled conduit control valve is connected, which as a function of an adjustable temperature opens the flow up to a maximum value if the temperature of the water flowing through the circular conduit is above a set-point value, and limits the flow to a minimum value if the temperature is below it, the conduit control valve preferably being connected within the circular conduit downstream of the last consumer thereof or being integrated in a connection fitting between circular conduit and main conduit of the conduit system.

This means, for achieving a specific circulation it is proposed to combine the circular conduits with a controlled conduit control valve that below the temperature adjusted at the valve allows a residual flow only through the valve. If the temperature adjusted at the valve is exceeded, the temperature sensor of the valve will detect this, and the valve is opened, so that the circular conduit is fully flowed. When the target temperature is achieved, i.e. for instance 9° C., the passage through the valve is again limited to a residual flow, since the temperature sensor of the valve sets the valve to a position in which only a residual flow flows through the valve.

This residual flow is necessary to secure a continuous is flush around the temperature sensor in the valve and thus to obtain a continuous detection of the actual temperature in the respective circuit or conduit. By the temperature-dependent opening of the valve to full passage, there is a full flow through the individual sections only until the target temperature is obtained or only when the target temperature is exceeded, respectively.

For the same reason, the invention proposes that at least in one or in each floor-by-floor conduit with at least one consumer, a controlled conduit control valve is connected, which as a function of an adjustable temperature opens the flow up to a maximum value if the temperature of the water flowing through the conduit is above a set-point value, and limits the flow to a minimum value if the temperature is below it, the conduit control valve preferably being connected in the floor-by-floor conduit downstream of the last consumer integrated therein or being integrated in a connection fitting between floor-by-floor conduit and main conduit of the conduit system.

Likewise for the same reason the invention proposes that at least in one riser conduit with at least one consumer, a controlled conduit control valve is connected, which as a function of an adjustable temperature opens the flow up to a maximum value if the temperature of the water flowing through the conduit is above a set-point value, and limits the flow to a minimum value if the temperature is below it, the conduit control valve preferably being connected downstream of the last consumer.

In particular, it is provided that the conduit control valve is controlled by a temperature sensor or a temperature sensing actuator, which is arranged in the flow path of the water through the conduit control valve.

In the normal mode of operation, not all of the controlled conduit control valves are opened at the same time, so that the full pressure of the circulation system is available for the flow through the respective section and thus a quick water exchange can take place in the respective section.

Further, it may preferably be provided that between the connection to the public water supply system and the conduit system, a filter for filtering out germs is installed.

The fresh water supplied from the drinking water network is directed through such a filter system, and any existing germs, such as for instance pseudomonads or Legionella, are filtered out from the water.

In order to secure a sufficient circulation in the system, it is further provided that a circulation pump is installed in the circulation system.

By the configuration according to the invention, substantial advantages are achieved. For instance, an inadmissible heating of the drinking water flowing through the system is prevented, when such conduits for drinking water are laid in parallel to supply lines in channels and wells, and the supply lines have higher temperatures or are passed by media having higher temperatures.

When the drinking water of the water supply companies has a too high entry temperature, it can be cooled down in the system to a temperature that suppresses a growth of pseudomonads or other germ types, and preferably the connection for the supplied fresh water is located before the entry of the cooling unit.

By the filter system installed at the entry side of the system, pseudomonads and Legionella can reliably be filtered out. In connection with the cold water circulation system according to the invention, the drinking water temperature can be determined such that regulatory provisions, for instance for hospitals or the like, can safely be fulfilled.

Subject matter of the invention is further a temperature-controlled valve, in particular a circulation valve, preferably a conduit control valve, for use in cold drinking water or cold domestic water systems, mainly for use in drinking or domestic water systems.

Following the fact that drinking water must be treated as a food, it must be secured that the temperature of the drinking water in the conduits is always in a hygienically favorable temperature range below 9° C. in order to avoid a contamination with bacteria. In order to secure this, the drinking water needs to regularly be exchanged in the conduits, as it is known for hot water systems, and this can be effected by a circulation or a flushing of the system.

From the EP 2 098 647, a connection fitting for the connection of circular conduits to riser or floor-by-floor conduits is known in the art that is intended to secure a reliable flushing effect of the circular conduit. When using this connection fitting, the circular conduits are flushed during flushing or circulation, irrespective of whether or not in the conduit the drinking water temperature is increased. Flushing is effected because of different flow resistances in the circular conduit and in the connection fitting. When flushing this leads to an unnecessarily high discharge of water to the wastewater system. Another disadvantage is that the flushed water from the existing circular conduits mixes with the fresh water and flows through the following circular conduits, this preventing a quick, complete water exchange. Since the line conduits and/or circular conduits normally have different lengths, unfavorable line conduits and/or circular conduits are poorly flushed only.

From the DE 100 56 715 A1 and the DE 10 2005 038 699 {GB 2,429,263}, valves controlled by a temperature motion transducer for use in hot water systems are known in the art, which allow above an adjustable water temperature a residual flow, and when falling below the adjusted temperature increase the volumetric flow through the valve in order to supply water with sufficient temperature to the line conduit or to the respective circular conduit.

Based on this prior art, it is the object of the invention to provide a temperature-controlled valve, in particular a valve controlled by a temperature motion transducer, which can be used in cold water systems and which in a circulation or flushing system of cold water adjusts the volumetric flow such that the cold drinking water or domestic water flows with a certain temperature through the conduits.

For achieving this object, the invention proposes that, as a function of a preferably adjustable or also fixed temperature, at a higher temperature of the medium flowing through the valve, the valve opens the flow to a maximum volumetric flow, and at a lower temperature or being at this temperature of the medium flowing through the valve closes the flow to a residual flow.

A simple solution is that for the respective valve, the temperature, at which the corresponding switching operation of the valve is to take place, is preset.

Preferably it is however provided that the desired temperature is adjustable at the valve. By the temperature-controlled valve, in particular by the valve controlled with a temperature motion transducer, it is possible to adjust the volumetric flow of the passing medium such that the drinking water or domestic water flows with the temperature adjusted at the valve through the corresponding conduits. In particular, it is secured that the valve used in cold water drinking or cold domestic water systems allows beneath an adjusted or adjustable medium temperature, for instance beneath 9° C., a residual flow only that serves for controlling the temperature of the valve, and increases above the adjustable temperature, i.e. at inadmissibly higher temperatures, the volumetric flow in order to secure a flushing and a removal of the inadmissibly heated water. Controlling can be made thermally by means of a thermocouple located in the volumetric flow, for instance coupled with a temperature motion transducer, or also by a control member controlled by an external energy depending on the medium temperature.

Likewise it is preferably provided that the amount of the residual flow that the valve lets pass beneath for instance 9° C. is adjustable. Thereby, the cooling energy required for the respective conduit can individually be adjusted for each conduit.

Preferably, however, it is provided that the valve comprises a control element determining the flow, which control element is controllable or adjustable into the two extreme positions immediately by an actuator detecting the temperature of the flowing medium or by a drive coupled therewith.

In particular it is preferably provided that the actuator is a thermocouple arranged in the flowing medium and comprising an expansion element such as a plunger.

In a preferred embodiment, it is provided that the valve comprises a housing with an inlet and an outlet for the flowing medium.

Another preferred embodiment is that the valve is provided in a connection fitting, by which a circular conduit is connected to a main supply line.

Further it is preferred that the valve is incorporated in a circular conduit branched off from a main supply line and that the valve is coupled with a control member such that when the valve is opened for maximum volumetric flow, the main supply line is blocked such that the volumetric flow of the main supply line flows through the circular conduit, and after reaching the set-point temperature the valve is reduced again to a residual flow and the main supply line is opened again.

The control unit provided for controlling the valve may be provided in a separate housing or also in a connection fitting, by which a circular conduit can be connected to a main supply line. The control unit may also be configured such that when the set-point temperature is exceeded, the integrated thermocouple switches, by means of the corresponding temperature motion transducer, to a higher flow, and simultaneously the main conduit of the system is blocked, so that the volumetric flow of the main conduit passes through the circular conduit in which the temperature-controlled valve is arranged. When then the set-point temperature is reached, the flow through the temperature-controlled valve can again be reduced to a residual flow, and the main conduit of the system can be opened.

### BRIEF DESCRIPTION OF THE DRAWING

Examples of execution of the invention are shown in the drawings and are described in the following in more detail. There are:

FIG. 1 a circulation cooling system with cooling generator and controlled conduit control valves in circular conduits;

FIG. 2, 2A a circulation cooling system with cooling generator and controlled conduit control valves in floor-by-floor conduits;

FIG. 3, 3A a circulation cooling system with cooling generator and controlled conduit control valves in the riser conduits;

FIG. 4 a sectional representation of a valve with valve insert, the valve being in the position “residual flow,” and the adjusted temperature corresponding to the medium temperature;

FIG. 5 a detail X of FIG. 4 in an enlarged scale;

FIG. 6 a sectional representation of the valve with valve housing and valve insert and the valve being opened, when the medium temperature is larger than the adjusted temperature;

FIG. 7 the detail Y of FIG. 6 in an enlarged view;

FIG. 8 a sectional representation of the valve with valve insert and the valve being closed;

FIG. 9 the detail Z of FIG. 8 in an enlarged detail view;

FIG. 10 a top view of a corresponding valve with disassembled handwheel for adjusting the opening temperature;

FIG. 11 a corresponding valve with disassembled handwheel for adjusting the opening temperature in an isometric view;

FIG. 12 a combination of a valve with a connection fitting in a partially sectional view;

FIG. 13 a valve insert in a central longitudinal section.

### DETAILED DESCRIPTION

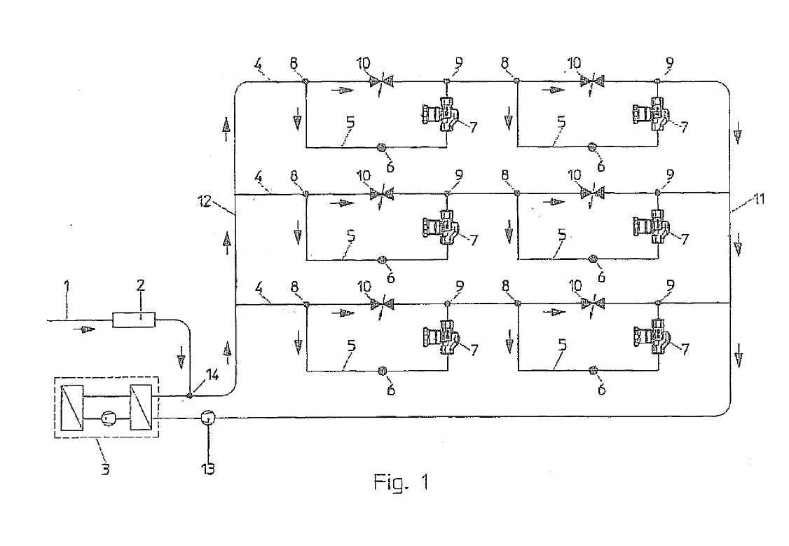

In FIG. 1, a cold water circulation system according to the invention is shown. Herein, the fresh water from the public drinking water network is supplied through a connection 1 and conducted through a filter 2, which filters out potentially existing germs, such as for instance pseudomonads or Legionella, from the fresh water. Through a connection point 14, the fresh water is conducted into the circulation system when tapping. In the circulation system being described in the following, the circulation is maintained by a circulation pump 13. The water circulating in the circulation circuit is then conducted through a cooling unit cooling the water down, preferably to temperatures below 9° C., and thus a hygienically advantageous temperature in the system is secured. The cooled water is conducted through the system in the direction of the arrow and is then distributed through the riser conduit 12 to the individual floor-by-floor conduits 4. To the individual floor-by-floor conduits 4, circular conduits 5 are connected by exits 8 and entries 9. The flow path is shown in the circular conduits 5 by adjacent arrows. In this direction of flow, consumers 6, such as for instance shower, tap or the like are provided in the circular conduits 5, as well as a controlled conduit control valve 7. The conduit control valve is connected in the circular conduit 5 downstream of the last consumer 6. It may also be integrated in a connection fitting, which is arranged in the area of the entry 9.

The controlled conduit control valve 7 can be adjusted to a set-point temperature, and when the latter is exceeded, the controlled conduit control valve 7, for instance by means of a thermal sensor, is opened, and when the set-point temperature is fallen below, the conduit control valve 7 is closed to a residual flow. This residual flow in the controlled conduit control valve 7 continuously flushes the thermal sensor and can thus detect the actual temperature of the water in the circular conduit 5. It is advantageous, to install in the floor-by-floor conduit 4 between the exit 8 and the entry 9 of the circular conduit a throttle 10, for instance a static control valve having a throttle function in order to provide a hydraulic adjustment between the circular conduit 5 and the floor-by-floor conduit 4, and thus to secure the residual flow in the controlled conduit control valve 7.

When the temperature in one of the circular conduits 5 exceeds the value adjusted at the respective conduit control valve 7, the passage through the conduit control valve is fully opened, and the resistance in the conduit system is distinctly reduced below the resistance of the adjustable throttle 10. This leads to that the full circulation flow is conducted through the circular conduit 5, until the desired water temperature is reached again in the circular conduit 5, so that the conduit control valve 7 is adjusted to the position with minimum passage. In this way, it is achieved that there is only flow through that circular conduit 5 in which the admissible set-point temperature is exceeded, and then with the maximum volumetric flow, so that a quick exchange with fresh water takes place.

In the drawing, on the right-hand side, the return conduit 11 is shown.

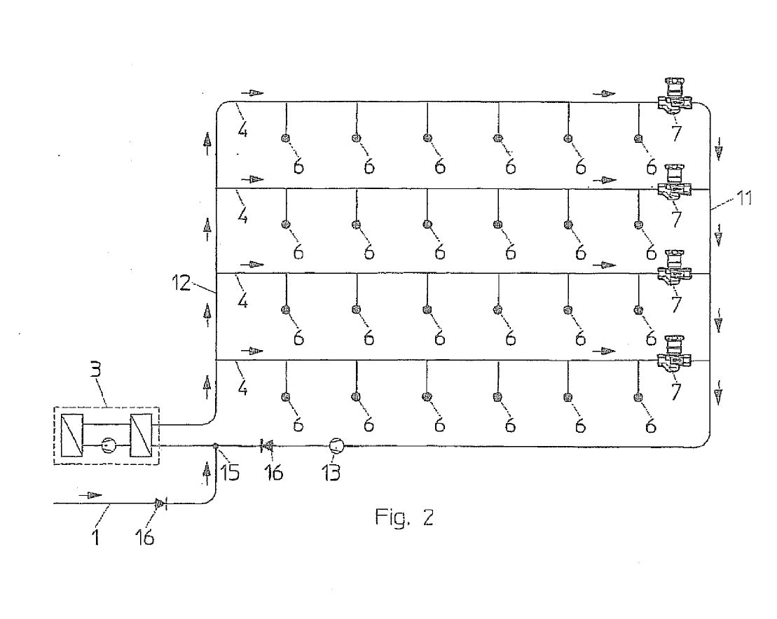

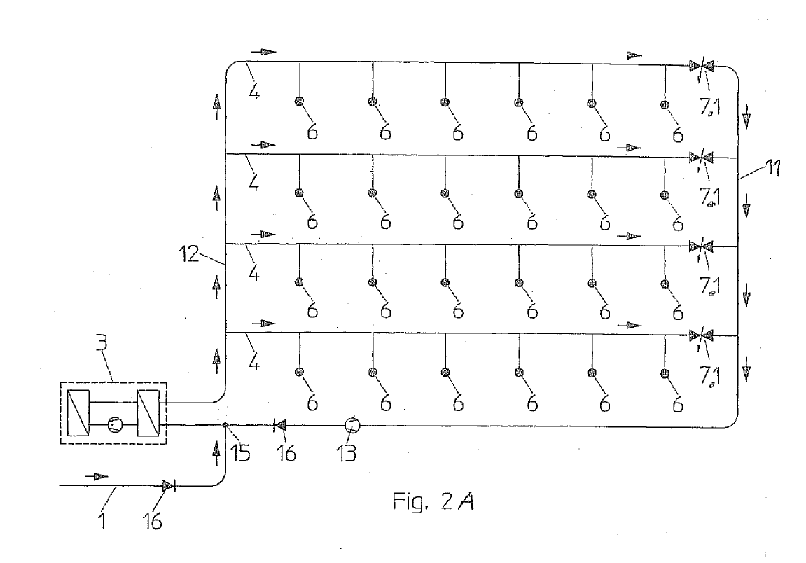

FIG. 2, 2A shows another embodiment of a cold water circulation system according to the invention. In this case, the fresh water is supplied from the public drinking water supply network to the circulation system at the connection 1 upstream of the cooling unit 3 through an entry 15, so that the supplied fresh water is immediately cooled, which is particularly advantageous, when the fresh water for instance in summer time has an increased temperature. The circulation of the cold water is again secured by a circulation pump 13. Through a riser conduit 12, several floor-by-floor conduits 4 are supplied, to which several consumers 6 are respectively connected. At each end of the floor-by-floor conduits 4 downstream of the connected consumers 6, a controlled conduit control valve 7, 7.1 is arranged. As already mentioned with respect to FIG. 1, this controlled conduit control valve 7, 7.1 has, beneath an adjustable temperature, a residual flow for the determination of the actual temperature of the water in the respective floor-by-floor conduit 4 by the thermal sensor of the conduit control valve 7, 7.1. When the adjusted temperature is exceeded, the controlled conduit control valve 7, 7.1 opens, and maximum circulation volumetric flows through the respective floor-by-floor conduit 4. Thus, a quick and specific exchange of the water in the respective floor-by-floor conduit is possible. Through the return conduit 11 serving as a collector conduit, the water from the floor-by-floor conduits 4 is again supplied to the cryogenic unit 3.

A backflow preventer 16 at the bottom in the return conduit and a backflow preventer 16 in the supply line of the fresh waters (connection 1) prevents in case of lacking water removal, a backpressure of the circulation water by the circulation pump 13 into the public drinking water supply network. Further, the backflow preventer 16 between the entry point 15 and the circulation pump 13 prevents that the water, due to a differential pressure caused by the pressure drop when tapping, can flow opposite to the circulation direction.

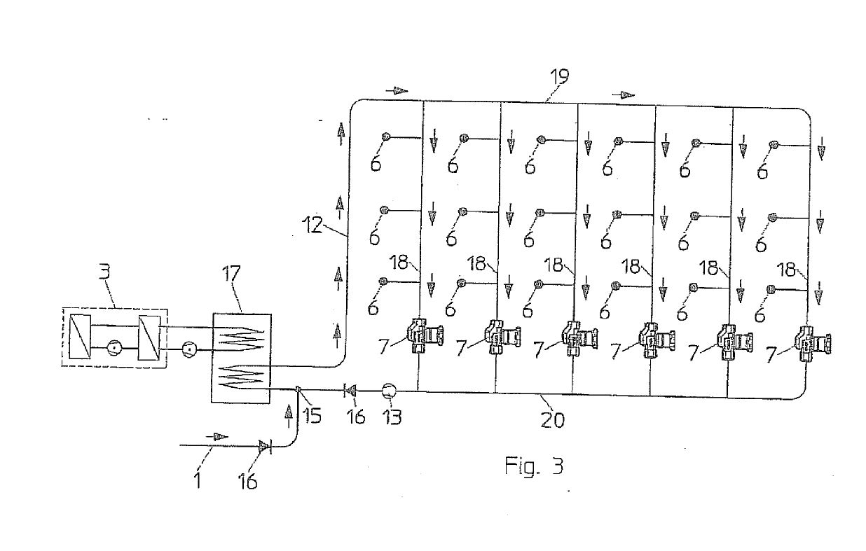

In FIG. 3, 3A finally, another embodiment of a cold water circulation system is shown. As shown in FIG. 2 already, the fresh water is supplied at the connection 1 through an entry 15 upstream of a cooling unit 3 into the circulation system. The cooling unit 3 comprises in this embodiment a cryogenic unit (reference numeral 3) for generating coolness, preferably for instance a heat pump and a cold storage 17 communicating therewith in which the produced cold is stored. The drinking water of the circulation system is conducted through this cold storage 17. Thereby, an inadmissible temperature rise with large water consumptions can be avoided. With low or no water consumption at all (for instance during the night), the storage can then be cooled down again by the cryogenic unit (3) to the required temperature level. The circulation of the water is again maintained by the circulation pump 13, conducted through the cold storage 17 and through the riser conduit 12 to the upper distributor conduit 19, which distributes the water to one or several floor-by-floor conduits 18. In these floor-by-floor conduits 18, again several consumers 6 are arranged, and in the section at the downstream end of the floor-by-floor conduit 18, a controlled conduit control valve 7, 7.1 is connected in the circuit. The function of this conduit control valve 7, 7.1 is the same, as described for the other embodiments, i.e. beneath an adjustable temperature, the controlled conduit control valve 7, 7.1 allows a residual flow only. When the adjusted temperature is exceeded, the full flow is opened, and the water of the respective conduit 18 is conducted into the collector conduit 20, which supplies the water to the cooling unit 3.

In FIG. 4, a temperature-controlled valve 101, in particular a control valve in an embodiment as a straightway valve is shown. A valve insert 105 is inserted in a valve housing 102 that has an inlet 103 and an outlet 104. The valve insert 105 is inserted with its lower end in a chamber 125 of the valve housing 102. The flowing medium can flow in through a bottom opening 115 of a sleeve 106 of the valve insert 105 and flow off through radial openings 126 of the sleeve 106 and through the outlet 104. In the sleeve 106 of the valve insert 105, a main spindle 107 at the top in the drawings to be operated from outside is held. Between the interior end the main spindle 107 and the bottom of the sleeve 106 comprising the bottom opening 115, a spring member 113 in the form of a return spring is arranged, which is supported at the bottom of the sleeve 106 and at a thermocouple 111 expanding under influence of temperature in parallel to the spindle axis, and in turn being supported at the interior spindle end. The thermocouple 111 is positively coupled with a control element 112, i.e. preferably joined, which forms, with its external contour 128 and a contour 127 formed in the interior of the sleeve 106, a flow gap 114, through which the flowing fluid can flow to the radial openings 126 of the sleeve 106 and then to the outlet 104.

The flowing medium flows through the bottom opening 115 located in the longitudinal axis of the valve insert 105 and flushed the thermocouple 111 being directly in the volumetric flow. The thermocouple 111 is supported at another spindle 109 for temperature adjustment provided coaxially with the main spindle 107.

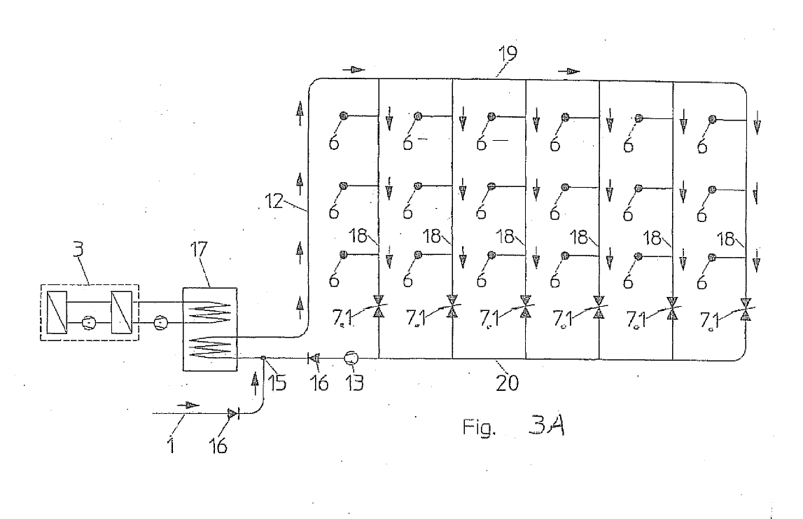

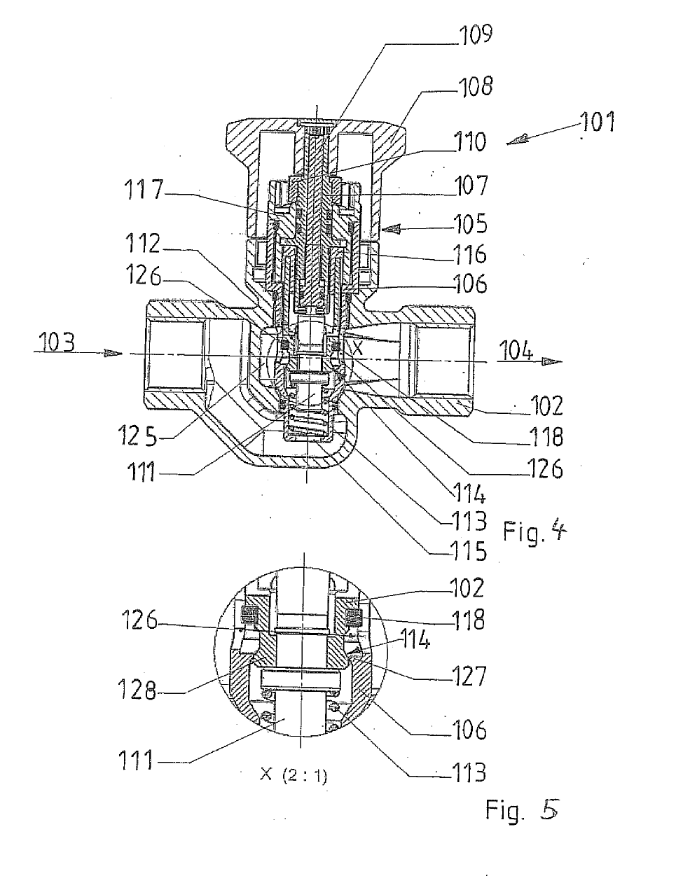

In the representation according to FIGS. 4 and 5, the valve 101 is shown in the condition “residual flow,” i.e., the temperature of the flowing medium is lower than or equal to the preset set-point temperature or the set-point temperature adjusted with the spindle 109 for temperature adjustment. In this position, the flow gap 114 thus has its smallest dimension. The volumetric flow is just such that the thermocouple 111 is sufficiently flushed in order to detect the actual medium temperature.

In FIG. 5, a detail section is shown in an enlarged scale, making the flow gap 114 clear.

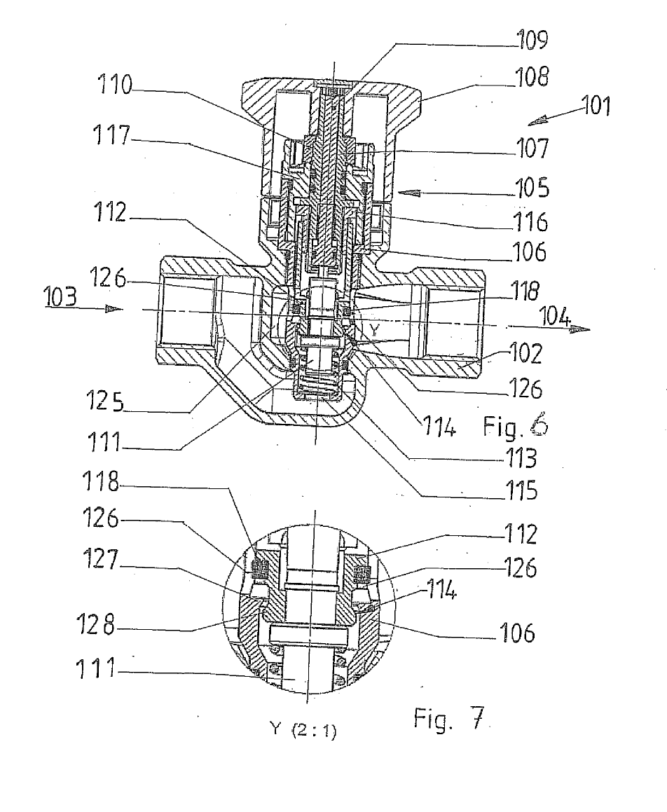

In FIG. 6, the temperature-controlled control valve 101 is shown in the opened condition, i.e., the temperature of the flowing medium is higher than the set-point temperature having been preset or adjusted by means of the temperature adjustment spindle 109. Due to the higher temperature of the medium flowing around the thermocouple 111, the latter will expand, respectively its expansion element, and that in the direction parallel to the spindle axis. The front face of the main spindle 107, or in the embodiment of the spindle 109 serves as a firm stop for the expanding thermocouple 111, so that the travel of the thermocouple 111 is absorbed by the return spring 113, and thus takes place axially in the direction of the bottom opening 115 of the sleeve 106 of the valve insert 105. The control element 112 joined with the thermocouple 111 positively follows this axial travel, whereby the control gap 114 becomes larger, because the displacement of the contour 128 of the control element 112 compared to the contour 127 of the sleeve 106. This increase of the flow gap 114 has as a consequence an increase of the volumetric flows.

In FIG. 7, the corresponding detail of FIG. 6 is shown in the enlarged scale.

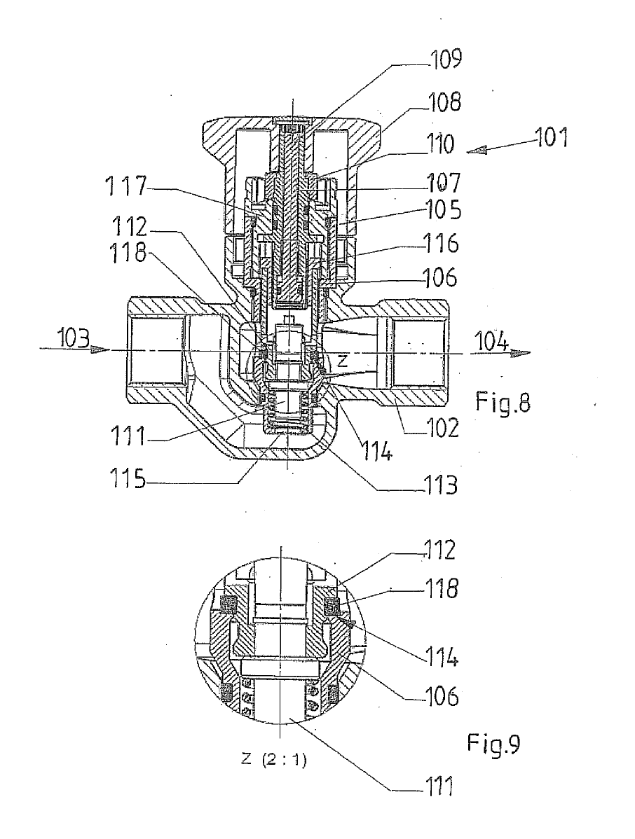

In FIGS. 8 and 9, another feature is shown. In FIG. 8, the control valve is shown in a closed condition. By turning the handwheel 108 mounted on top of the main spindle 107, the coupling sleeve 116 supported safely against rotation in a head sleeve 117 is axially displaced on the main spindle 107 by means of a transmission thread. When the valve 101 is closed, an axial movement of the coupling sleeve 116 occurs in the direction of the bottom opening 115 of the sleeve 106 of the valve insert 105, and the control element 112 supported at the coupling sleeve 116 is taken along in the same direction together with the thermocouple 111 against the force of the return spring 113. The displacement occurs to such an extent, until a sealing ring 118 that is fixed at the control element 112 contacts the seat of the control gap 114 and thus blocks the volumetric flow.

The corresponding detail is shown in the enlarged scale in FIG. 9.

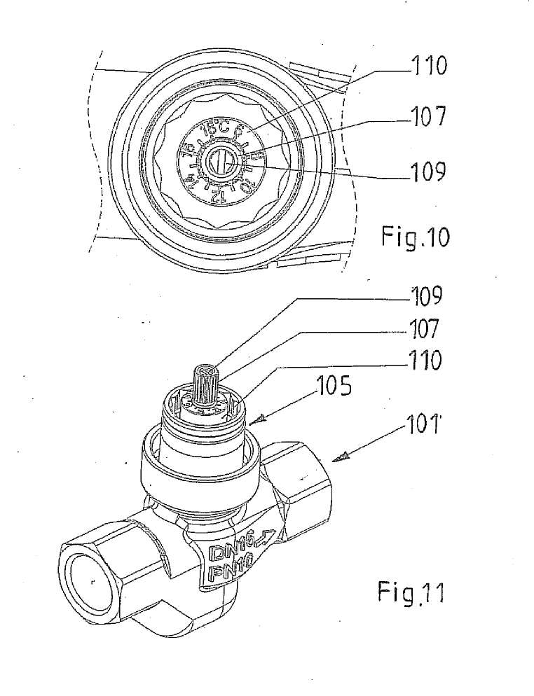

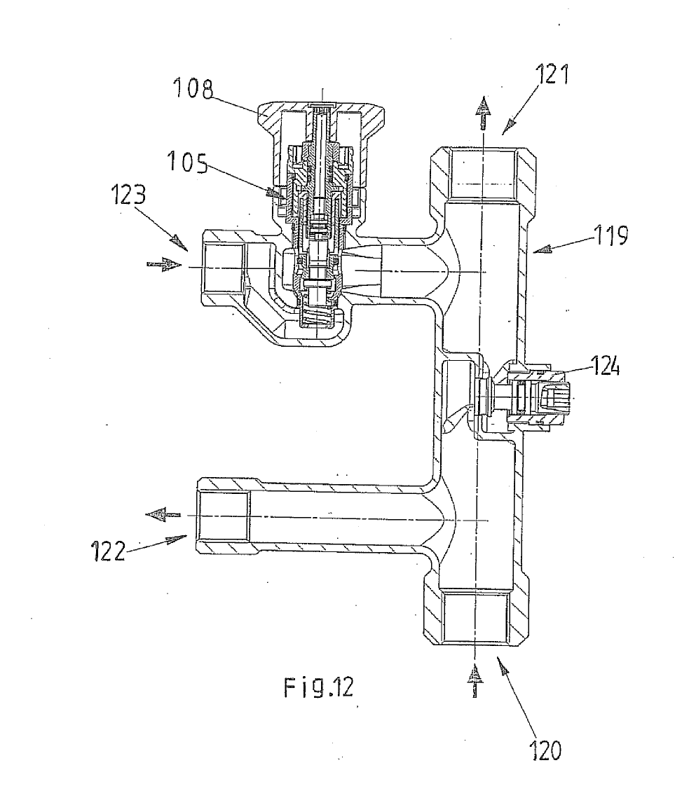

In FIGS. 10 and 11 is shown, how the adjustment of the temperature can be made. The adjustment takes place with the temperature adjustment spindle 109 provided coaxially with the main spindle 107, the spindle 109 having on its upper external front face a marking. At the top of the main spindle 107, a graduated ring 110 with a corresponding temperature range is disposed. By turning the temperature adjustment spindle 109 relative to the main spindle 107, the marking of the temperature adjustment spindle 109 can be adjusted to a certain temperature on the graduated ring 110. The turning movement of the temperature adjustment spindle 109 is transformed by a thread into an axial movement relative to the main spindle 107. By the axial movement of the temperature adjustment spindle 109, the travel position of the thermocouple 111 resting against the front face of the temperature adjustment spindle 109 located inside of the valve 101 is displaced corresponding to the adjustment.

In FIG. 12, a variant is shown. Here, a connection fitting 119 for circular conduits is provided. An inlet connection 120 and an outlet connection 121 connect the connection fitting 119 to the conduit of a drinking water system. In the direction of flow of the medium, shown by arrows, following the inlet connection 120, an outlet connection 122 branches off to a circular conduit with one or several consumers. Following the consumers, the circular conduit is connected by the inlet connection 123 to the connection fitting 119. Following the inlet connection 123 from the circular conduit, the valve insert 105 is arranged. The housing of the connection fitting thus forms the holding fixture for the valve insert 105 and the respective inlet and outlet possibility.

By the respective valve insert 105, the volumetric flow is reduced to a residual flow, as long as the temperature of the flowing medium is below the temperature adjusted at the valve insert 105. Downstream of the valve insert 105, the connection enters again into the housing of the connection fitting 119.

In the connection being straight in the embodiment between the connections 120 and 121 and the branches to and from the circular conduit 122 and 123, a hydraulic resistance, for instance in the embodiment a throttle valve 124 may be incorporated. Mounting such connection fittings 119 in the cold water circulation system makes the hydraulic adjustment of flow resistances in different system parts possible. The drawing shows just one fundamental arrangement of such components.

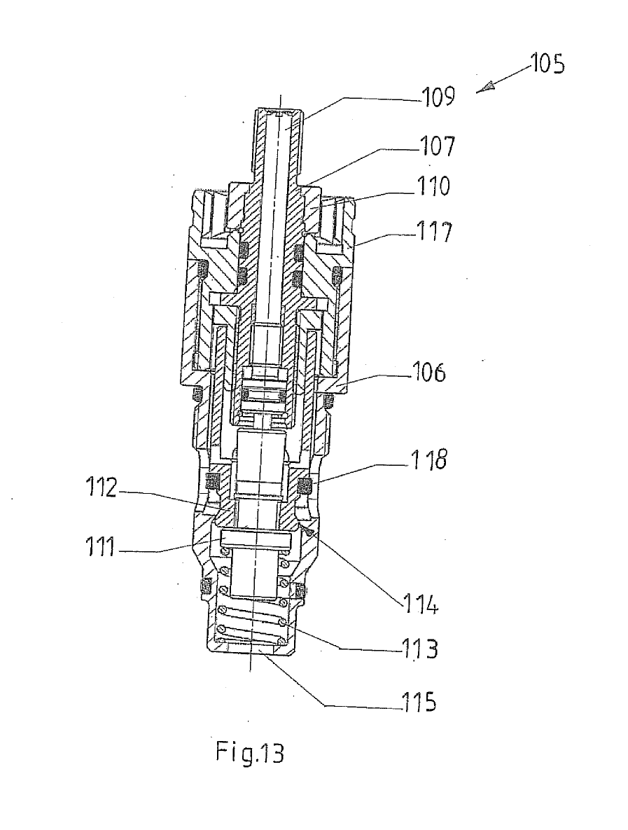

In FIG. 13 finally, a corresponding valve insert 105 is shown, as it is used in the straightway valve according to FIG. 4 or in the connection fitting 119 according to FIG. 12.

The invention is not limited to the embodiments, but is in many ways variable within the scope of the disclosure.

All novel individual or combined features disclosed in the description and/or drawing are deemed essential for the invention.

We claim:

1. A drinking or domestic water system comprising:
a conduit system that has a connection to a public water supply system and at least one supply conduit or riser conduit with at least one floor-by-floor conduit branching therefrom or at least one circular conduit branched in the flow direction of the water from the riser conduit or from the floor-by-floor conduit,
at least one consumer connected at the riser conduit or at the floor-by-floor conduit or in the circular conduit,
a return conduit into which the supply conduit or the riser conduit or the floor-by-floor conduit or the circular conduit enters, the conduit system composed of supply conduit or riser conduit and return conduit forming a closed circulation conduit, and
in this circulation conduit a unit for cooling the water flowing through is integrated, by means of which the drinking or domestic water can be cooled or is cooled to a predetermined temperature.

2. The drinking or domestic water system defined in claim 1, wherein the connection to the water supply system is located between the exit of the cooling unit and the supply or riser conduit.

3. The drinking or domestic water system defined in claim 1, wherein the connection to the water supply system is located in the circular conduit upstream of the entry of the cooling unit.

4. The drinking or domestic water system defined in claim 1, wherein in the floor-by-floor conduits that are connected in parallel to the circular conduits, static conduit control valves for a hydraulic adjustment of the conduits among each other are installed.

5. The drinking or domestic water system defined in claim 1, wherein in one or each circular conduit with at least one consumer, a controlled conduit control valve is connected, which as a function of an adjustable temperature opens the flow up to a maximum value if the temperature of the water flowing through the circular conduit is above a set-point value, and limits the flow to a minimum value if the temperature is below it, the conduit control valve being connected within the circular conduit downstream of the last consumer thereof or being integrated in a connection fitting between circular conduit and main conduit of the conduit system.

6. The drinking or domestic water system defined in claim 1, wherein at least in one or in each floor-by-floor conduit with at least one consumer, a static conduit control valve for a hydraulic adjustment of the conduits among each other is connected, the conduit control valve being connected in the floor-by-floor conduit downstream of the last consumer integrated therein or being integrated in a connection fitting between floor-by-floor conduit and main conduit of the conduit system.

7. The drinking or domestic water system defined in claim 1, wherein at least in one or in each floor-by-floor conduit with at least one consumer, a controlled conduit control valve is connected, which as a function of an adjustable temperature opens the flow up to a maximum value if the temperature of the water flowing through the conduit is above a set-point value, and limits the flow to a minimum value if the temperature is below it, the conduit control valve being connected in the floor-by-floor conduit downstream of the last consumer integrated therein or being integrated in a connection fitting between floor-by-floor conduit and main conduit of the conduit system.

8. The drinking or domestic water system defined in claim 1, wherein at least in one or in each riser conduit with at least one consumer, a static conduit control valve for a hydraulic adjustment of the conduits among each other is connected, the conduit control valve being connected in the riser conduit downstream of the last consumer integrated therein or being integrated in a connection fitting between riser conduit and main conduit of the conduit system.

9. The drinking or domestic water system defined in claim 1, wherein at least in one riser conduit with at least one consumer, a controlled conduit control valve is connected, which as a function of an adjustable temperature opens the flow up to a maximum value if the temperature of the water flowing through the conduit is above a set-point value, and limits the flow to a minimum value if the temperature is below it, the conduit control valve being connected downstream of the last consumer.

10. The drinking or domestic water system defined in claim 4, wherein the conduit control valve is controlled by a temperature sensor or a temperature sensing actuator, which is arranged in the flow path of the water through the conduit control valve.

11. The drinking or domestic water system defined in claim 1, wherein between the connection to the public water supply system and the conduit system, a filter for filtering out germs is installed.

12. The drinking or domestic water system defined in claim 1, wherein a circulation pump is installed in the circulation system.

13. A temperature-controlled conduit control valve for use in cold water drinking or cold domestic water systems, mainly for use in drinking or domestic water systems according to claim 1, wherein, as a function of an adjustable or fixed temperature, the valve opens the flow to a maximum volumetric flow, when the medium flowing through the valve is at a higher temperature, and the valve closes the flow to a residual flow, when the medium flowing through the valve is at a lower temperature or is at this temperature.

14. The valve defined in claim 13, wherein the valve comprises a control element determining the flow, which control element is controllable or adjustable into the two extreme positions immediately by an actuator detecting the temperature of the flowing medium or by a drive coupled therewith.

15. The valve defined in claim 14, wherein the actuator is a thermocouple arranged in the flowing medium and comprising an expansion element such as a plunger.

16. The valve defined in claim 13, wherein the valve comprises a housing with an inlet and an outlet for the flowing medium.

17. The valve defined in claim 13, wherein the valve is provided in a connection fitting, by which a circular conduit is connected to a main supply line.

18. The valve defined in claim 13, wherein the valve is incorporated in a circular conduit branched off from a main supply line, and that the valve is coupled with a control member such that when the valve is opened for maximum volumetric flow, the main supply line is blocked such that the volumetric flow of the main supply line flows through the circular conduit, and after reaching the set-point temperature the valve is reduced again to a residual flow, and the main supply line is opened again.

19. The valve defined in claim 13, wherein the valve comprises a valve housing with a fluid inlet and a fluid outlet as well as a chamber being in connection therewith in which a valve insert is inserted that is in connection with the inlet and the outlet, the valve insert comprising a sleeve in which a main spindle to be operated from outside is held and which comprises a bottom opening that is open toward the inlet, as well as radial openings, which are open toward the outlet, between the interior end of the main spindle and the bottom of the sleeve comprising the bottom opening, a spring being arranged, which is supported at the bottom and at a thermocouple expanding under influence of temperature in parallel to the spindle axis, and being supported at the interior spindle end, the thermocouple being positively coupled with a control element, which forms, with its external contour and a contour formed in the interior of the sleeve, a flow gap, through which the flowing fluid flows to the radial openings of the sleeve and then to the outlet.
